(19) United States
(12) Patent Application Publication
(10) Pub. No.: US 2020/0202086 A1
(43) Pub. Date: Jun. 25, 2020

(54) SMART PREP TABLE AND METHOD OF FOOD TRACEABILITY

(71) Applicant: AVERY DENNISON RETAIL INFORMATION SERVICES LLC, Mentor, OH (US)

(72) Inventors: Jeanne Duckett, Franklin, OH (US); Lori Porter, Dayton, OH (US)

(21) Appl. No.: 16/723,260

(22) Filed: Dec. 20, 2019

Related U.S. Application Data
(60) Provisional application No. 62/782,763, filed on Dec. 20, 2018.

(51) Int. Cl. G06K 7/10; G06K 19/06

(52) U.S. Cl. CPC G06K 7/10316; G06K 19/06037

(57) ABSTRACT

A smart prep table and associated method of food traceability is disclosed which comprises an RFID system used in conjunction with a machine vision or intelligent imaging system to unobtrusively obtain, maintain and update information on the current inventory levels of the food items and/or ingredients on or in proximity to the prep table. The device and related method of the present invention may also be used to gather traceability data with respect to the food items and/or ingredients, and the food products that result therefrom. In turn, the traceability data may be provided to consumers or other users, and may also be used to generate a variety of different consumer or user alerts.

### CROSS REFERENCE TO RELATED APPLICATION(S)

The present application claims priority from U.S. provisional utility patent application No. 62/782,763 filed Dec. 20, 2018, which is incorporated herein by reference in its entirety.

### BACKGROUND

The present invention relates generally to a smart preparation or “prep” table for a foodservice location, and a related method of traceability for food items, ingredients and the resulting food products that are prepared therefrom. More specifically, the smart prep table utilizes a radio frequency identification (RFID) system in combination with machine vision or intelligent imaging systems to unobtrusively obtain, maintain and update accurate information on the prep table while gathering food product traceability data in the background for the food products prepared on or in proximity to the prep table.

By way of background and generally stated, radio-frequency identification or RFID is the use of electromagnetic energy to stimulate a responsive device (known as a RFID “tag” or transponder) to identify itself and, in some cases, provide additionally stored data in the tag. RFID tags typically include a semiconductor device commonly called the “chip” on which are formed a memory and operating circuitry, which is connected to an antenna. Typically, RFID tags act as transponders, providing information stored in the chip memory in response to a radio frequency interrogation signal received from a RFID reader, also referred to as an interrogator. In the case of passive RFID devices, the energy of the interrogation signal also provides the necessary energy to operate the RFID device.

RFID tags may be incorporated into or attached to articles to be tracked, for example, food items, packages or ingredient containers. In some cases, the tag may be attached to the outside of an article with adhesive, tape, or other means and in other cases, the tag may be inserted within the article, such as being included in the packaging, located within the container of the article, or attached to the actual article or its packaging. The RFID tags are manufactured with a unique identification number which is typically a simple serial number of a few bytes with a check digit attached. This identification number is incorporated into the tag during manufacture. The user cannot alter this serial/identification number and manufacturers guarantee that each serial number is used only once. Such read-only RFID tags typically are permanently attached to an article to be tracked and, once attached, the serial number of the tag is associated with its host article in a computer data base.

The smart prep table and related method of the present invention utilizes a combination of RFID technology and machine vision or intelligent imaging systems, and is particularly suitable for food products prepared within a quick service restaurant. Accordingly, the present specification makes specific reference thereto. However, it will be appreciated by those of ordinary skill in the art that aspects of the present invention are also equally amenable to other like applications and devices. For example, it is also contemplated that the smart prep table and method of the present invention could be deployed in other foodservice locations such as a bar, mobile kitchen, hotel, soup kitchen, food truck, etc. Further, the traceability system of the present invention allows for traceability of the food product item from its generation to its ultimate delivery to a consumer, donation center or disposal site, and provides users and consumers with greater transparency into the socio and environmental impacts of the food products that they consume and their production.

By way of background with respect to the traceability of food products, items and ingredients, the need for food traceability from the kitchen to the consumer is becoming increasingly self-evident. Every day seems to bring a new food recall. There are also growing environmental, socio-economic and ethical issues and concerns surrounding the amount of food waste occurring on a daily basis. For example, it has been reported that Americans alone waste as much as 150,000 tons of food each day, and that, annually, the wasted food was grown on the equivalent of over 30 million acres of cropland, or approximately 7.5% of all harvested cropland in the United States.

Additionally, today's consumers are becoming increasingly concerned about food product transparency and the socio and environmental impacts of said food product items and their production. While there has been literature written about the need for traceability in the foodservice industry, there are no practical implementations of tracing food from its generation or preparation through to the consumer or the ultimate disposal of the food product. Several reasons for the lack of a practical solution exist.

First, the skill level and available time of the average foodservice worker is relatively limited, thereby reducing the potential of using complex food traceability systems that require multiple steps and extensive training. Second, available food traceability technology in the kitchen and other food preparation locations is somewhat limited, and typically consists of manual processes requiring the careful manual recording of information, the use of color dots, and finally transcribing the information into a digital record, all of which is not only time consuming, but cost prohibitive and prone to human error.

Additionally, in a quick service restaurant, it is particularly desirable to have a method of automatically tying the food items and ingredients on the prep table that are ultimately used to create the end food product to traceability information so that the same can be provided to the consumer, used to manage inventories of food items and/or ingredients, alert users or consumers to food product expiration dates, and various other benefits. For example, it is desirable for a traceability method to include capturing the unique item information, batch/serial number, relevant “use by” date or expiration date information, product weight, etc. associated with the food items or ingredients used to produce a food product. This type of information can, in turn, be used in the downstream traceability of the resulting food product, to manage inventories of the food items and ingredients, calculate expiration or other relevant dates for the resulting food products, issue alerts to consumer, provide product and product sourcing information to the consumer, etc.

Therefore, there exists in the art a long felt need for a smart prep table device and related method for food traceability that can be deployed in a quick service restaurant, or other suitable foodservice environment, and that automatically ties the food items and ingredients on the prep table to the traceability information of the overall food product for ease of use and unobtrusive operation. There also exists in the art a long felt need for a smart prep table and related traceability method that alerts a user when a food item or ingredient is present or absent from the prep table, and that helps the user manage inventory levels of food items and ingredients and to calculate relevant food product dates like “best by” dates, expiration dates, etc.

There further exists in the art a long felt need for a traceability method that is capable of providing various alerts to a user or consumer, and that permits the user or consumer to access traceability, sourcing and other useful information about a food product on demand. Specifically, the traceability information may comprise, but is not limited to, unique item information, batch/serial number, relevant date information, food item or ingredient volume or weight, sourcing information (e.g., supplier name or country of origin) or any other information that suits consumer demand or preference. Having the ability to trace food products from their origin to their ultimate destination will also enable governments, companies and individuals in the food production chain to improve the overall quality and safety of the food product items they produce, reduce hunger and food waste, and improve overall efficiencies and the sustainability of valuable resources used in the food product production process.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a smart prep table device utilizing an RFID system in combination with a machine vision or intelligent imaging system to unobtrusively obtain, maintain and update, as necessary, real-time information on the current inventory levels of the food items and other ingredients on the prep table and the resulting food product produced therefrom, as well as to gather the traceability data of the same in the background and with minimal effort from the foodservice worker. Specifically, the traceability data may comprise, but is not limited to, unique item information, batch/serial number, weights, descriptions, and relevant date information about the food items and ingredients on the smart prep table device and the resulting food product produced therefrom.

In an alternative embodiment of the present invention, the smart prep table device utilized for food traceability comprises at least one food item or ingredient containing a RFID enabled smart label that comprises a unique identifier, a starting weight, and a container size for the food item or ingredient. Typically, the smart label also comprises traceability information such as a food item or ingredient name, a global trade item number (GTIN), a serial number, a supplier name, country of origin, a prep date, a “best by” or expiration date, and a quick response (QR) code or other barcode, 2D code or the like, that can be used by a consumer or other user to access the traceability or other useful information. The smart prep table device also comprises an RFID reader which reads traceability information from the RFID enabled smart label; and an intelligent imaging system, which captures images of the food item and/or ingredients and processes the images to be read by the RFID reader. Thus, the RFID reader works in conjunction with the machine vision or intelligent imaging system to gather traceability data from the RFID enabled smart label of the food item and/or ingredient on the smart prep table device.

In an alternative embodiment of the present invention, a method for food traceability is disclosed. Generally stated, the method comprises positioning a food item or ingredient labeled with a smart label on or in proximity to the smart prep table, and determining whether the food item or ingredient was previously on or near the smart prep table. This determination is made possible by capturing an image of the food item smart label, reading an RFID tag on the food item or ingredient, and locating the inventory of the food item or ingredient. The method of the present invention then proceeds to also determine whether the food item or ingredient is in or out of stock. If the food item storage container is empty or the ingredient is out of stock, then the device captures traceability data and returns to the beginning of the process. It is also contemplated that the smart prep table device of the present invention could be in communication with the user's inventory management system, and generate an order to the supplier of the food item/ingredient to replenish the out of stock food item or ingredient.

If, on the other hand, the food item or ingredient container is not empty, the inventory may be updated with a monitoring status. For example, as stated above, the device of the present invention could be in communication with the user's inventory management system and could automatically update the user's inventory to reflect the amount of food item or ingredient recently used or consumed on the smart prep table (as it is no longer part of the available inventory) by weight, volume or any other suitable metric. In this manner, the user is able to maintain a real-time inventory of food items and ingredients available for use, and avoid the downtime typically associated with running out of and having to replenish the food items and/or ingredients necessary to create the food products.

The smart prep table device and related method of the present invention is also capable of detecting whether a necessary food item or ingredient is present on the prep table and/or if said food item or ingredient is past its expiration or “best by” date. For example, if the food item or ingredient is past its expiration date, the device can alert the user of the same, thereby insuring that the food products are consistently manufactured in the same manner over time, and that the food products do not include expired or spoiled food items or ingredients thereby improving overall safety.

Once the food product has been successfully manufactured, the method of the present invention proceeds to determine if it is time to clear the smart prep table. If it is not time to clear the smart prep table, for example because there are additional food products to manufacture, the method proceeds to capture and analyze the image(s) generated by the intelligent imaging systems and check for empty food item or ingredient containers. If, on the other hand, it is time to clear the smart prep table, then the method proceeds to check all the food items, ingredients and resulting food products on the smart prep table for viability and, for example, to update the inventory management system. The method then proceeds to process each food item and ingredient on the smart prep table to be stored, donated or properly disposed of, for example, if it is past its expiration or “best by” date. Finally, the traceability information for each food item, ingredient and resulting food product on the smart prep table is captured and retained, and inventory levels may be updated.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a front perspective view of one potential embodiment of a smart prep table in accordance with the disclosed architecture.

FIG. 2 illustrates a perspective view of one example of an RFID enabled label with a quick response (QR) code contained thereon and in accordance with the disclosed architecture.

FIG. 3 illustrates a flowchart of one potential embodiment of the method for maintaining the food traceability prep system in accordance with the disclosed architecture.

FIG. 4 illustrates a perspective view of an inventory list in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

In one embodiment, the present invention discloses a smart prep table device that comprises an RFID system in combination with a machine vision or intelligent imaging system to unobtrusively obtain, maintain and update information on the current inventory levels of the food items and/or ingredients on or in proximity to the prep table device, as well as to gather the traceability data of the same in the background and with minimal effort from the foodservice worker. Thus, the smart prep table device captures information about the food items and ingredients on the smart prep table device including, without limitation, the unique item information, batch/serial number, weight, relevant date information, etc.

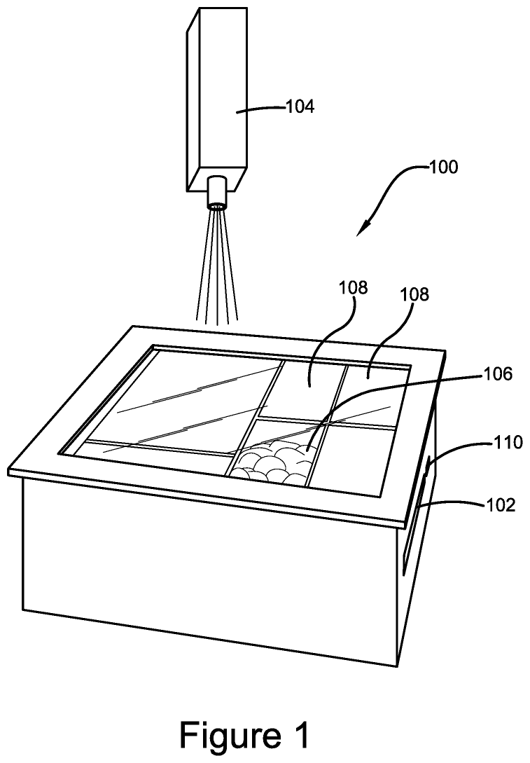

Referring initially to the drawings, FIG. 1 illustrates a front perspective view of one potential embodiment of a smart prep table device 100. Generally stated, smart prep table device 100 comprises an RFID reader 102 and an intelligent imaging system 104. The smart prep table device 100 can be any suitable prep table as is known in the art for storing and/or gathering ingredients and food items 106 and using the same to prep or manufacture a food product in a foodservice environment, such as a quick service or other type of restaurant. Further, smart prep table device 100 can be any suitable size, shape, and/or configuration as is known in the art without affecting the overall concept of the invention. One of ordinary skill in the art will appreciate that the shape, size and configuration of the smart prep table device 100 shown in FIG. 1 is for illustrative purposes only, and that many other shapes and sizes of the smart prep table device 100 are well within the scope of the present disclosure. Although the dimensions of the smart prep table device 100 (i.e., length, width, and height) are important design parameters for good performance, the smart prep table device 100 may be any shape, size or configuration that ensures optimal performance during use and/or suits user need or preference.

Typically, the smart prep table device 100 is manufactured of aluminum or stainless steel or any other suitable material as is known in the art for use in foodservice environments, and that can be easily cleaned and/or sanitized. The smart prep table device 100 is also typically divided (segmented) into various compartments or sections 108 for holding or storing various types of ingredients and food items 106 or the food products that result therefrom. Any suitable number of compartments or sections 108 can be utilized for the smart prep table device 100 depending on the wants and/or needs of a particular user and the overall nature of the food prep process. It is also contemplated that smart prep table 100 could further comprise a heater (not shown) for keeping prepped items warm, or an air conditioning unit (also not shown) for keeping the various food items and/or ingredients refrigerated to avoid spoilage.

The RFID reader 102 can be any suitable RFID reader as is known in the art. As previously stated, radio-frequency identification is the use of electromagnetic energy to stimulate a responsive device to identify itself. Typically, RFID readers act as interrogators, sending radio frequency interrogation signals to RFID tags, which function as transponders and provide information stored in the chip memory in response to a radio frequency interrogation signal received from the reader. In the case of passive RFID devices, the energy of the interrogation signal also provides the necessary energy to operate the RFID device.

RFID tags may be incorporated into or attached to articles to be tracked, for example, food items, packages or ingredient containers. In some cases, the tag may be attached to the outside of an article with adhesive, tape, or other means and in other cases, the tag may be inserted within the article, such as being included in the packaging, located within the container of the article, or attached to the article itself. The RFID tags are manufactured with a unique identification number which is typically a simple serial number of a few bytes with a check digit attached. This identification number is incorporated into the tag during manufacture. The user cannot alter this serial/identification number and manufacturers guarantee that each serial number is used only once. Such read-only RFID tags typically are permanently attached to an article to be tracked and, once attached, the serial number of the tag is associated with its host article in a computer data base.

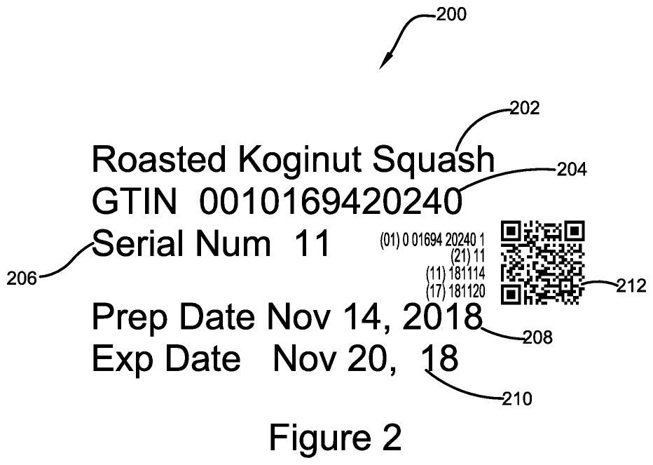

The RFID reader 102 preferably further comprises multiple patch antennas 110. A patch antenna is a radio antenna with a relatively low profile, which can be mounted on a flat surface and typically consists of a flat rectangular sheet or “patch”. Nonetheless, antenna 110 types are very diverse, and any suitable number or type of RFID antennas or RFID patch antennas can be utilized as is known in the art based on the needs and/or wants of the particular user. Typically, the RFID reader 102 reads or interrogates the RFID enabled smart labels (see e.g., smart label 200 in FIG. 2) and transmits the information from the labels 200 to the user. With respect to smart prep table device 100, the RFID reader 102 preferably obtains information from the smart labels 200 attached to the various food items and/or ingredients 106. For example, and without limitation, RFID reader 102 may obtain information about the food item and/or ingredient such as sourcing and traceability information, individual lot numbers, weight, product description, relevant date information such as prep dates, “best by” dates and expiration dates, supplier or vendor identification information, ordering frequency, remaining inventory levels, and any other information that is encoded in the smart labels to suit user need and/or preference.

The RFID reader 102 of the present invention also works in combination with a machine vision or intelligent imaging system 104. The intelligent imaging system 104 can be any suitable imaging system as is known in the art and is typically comprised of a combination of software and hardware products such as cameras. Generally stated, a machine vision or intelligent imaging system functions to collect an image or series of images of an object via one or more cameras, and then utilizes a software program to analyze the image or series of images and extract the desired information from the image and perform related analysis.

More specifically, the intelligent imaging system 104 of the present invention captures images of the prep table device 100 and the food items and ingredients 106 stored thereon (or the lack thereof), and processes and stores the images to be read by the RFID reader 102. Accordingly, and by way of example and not limitation, without user input (or with minimal user input) the imaging system 104 captures the traceability information for shipping the food items 106 from their source to the smart prep table device 100, monitors events for inventory status, and ships unneeded food items back to storage, donates the same, or sends the food items or ingredients for proper disposal if, for example, relevant expiration dates have past. Thus, the smart prep table device 100 integrates the imaging system 104 with the RFID reader 102 to enable the tying of unique identifiers, lot/serial numbers, relevant dates and other useful information to individual food items and ingredients 106 prepped for consumers. This tying of traceability information allows for a user to unobtrusively obtain, maintain and update as necessary accurate information on the smart prep table device 100 in regards to current inventory levels while gathering the traceability data in the background. Further, a user can also receive automatic alerts for, by way of example and not limitation, out of date food items or ingredients 106, out of stock or depleted inventory levels of food items or ingredients 106, the presence (or lack thereof) of critical food items or ingredients 106 at or in proximity to the smart prep table, or any other suitable alerts as are known in the art or desired depending on the needs and/or wants of a user.

Additionally, it is also contemplated that the smart prep table device 100 of the present invention could be in communication with the user's inventory management system and generate, for example and not by way of limitation, an order to the supplier to replenish an out of stock food item or ingredient or update the inventory to reflect food items or ingredients 106 consumed in the food product manufacturing process being performed on or in proximity to the smart prep table device 100. In this manner, a user can automatically maintain a real-time inventory of available food items and ingredients 106, and reduce the downtime typically associated with running out of and having to replenish the food items and/or ingredients necessary to create the food products. The device and related method of the present invention is also capable of detecting whether a necessary food item or ingredient 106 is present on the prep table and/or if said food item or ingredient 106 is past its expiration or “best by” date and alerting the user of the same, thereby insuring that the food products are consistently manufactured in the same manner over time and that the same do not include expired food items or ingredients 106. It should also be noted that imaging systems given, for example, starting weight and container size of a food item or ingredient 106 are able to further analyze and determine weight changes in the food item or ingredient 106. Also noted is that the smart prep table system could be preconfigured with food items and/or ingredients 106 on the prep table with their unique identifiers, starting weights, and/or container sizes.

FIG. 2 discloses an example of an RFID enabled label 200 (or smart label) for accessing inventory of the food items. The smart label 200 preferably comprises a food item name 202, a GTIN (global trade item number) number 204, a serial number 206, a prep date 208, an expiration date 210, and a QR code 212. Nonetheless, it will be appreciated by one of ordinary skill in the art that the smart label 200 depicted in FIG. 2 is only one potential embodiment of label 200, and that any other useful information can also be included on label 200 to suit user need and/or preference and without affecting the overall concept of the present invention.

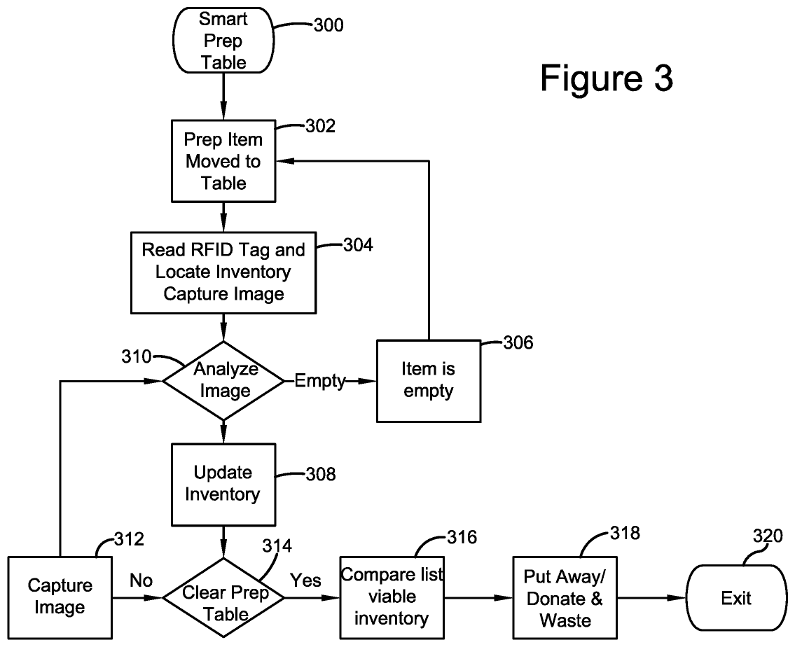

A method of food traceability associated with smart prep table device 100 is also provided and disclosed herein. For example, FIG. 3 illustrates a flowchart of one potential embodiment of the method for maintaining the food traceability prep system, wherein the smart prep table process is entered at 300. At 302, a food item or ingredient 106 labeled with a smart label (see e.g., smart label 200 in FIG. 2) is placed on or in proximity to the prep table. At 304, it is both determined that the food item/ingredient wasn't previously on the prep table, and that the food item/ingredient is scheduled to be on the prep table. Typically, the determination is achieved by capturing an image of the food item/ingredient label, reading an RFID tag on the food item/ingredient, and locating the inventory of the food item/ingredient. If this determination fails, an alert may be displayed for the user.

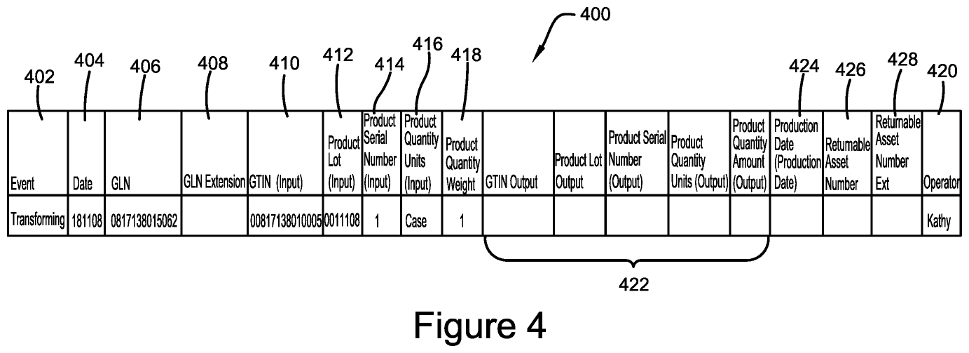

At 310, the captured image is analyzed and, if the food item/ingredient or container containing the same is empty, at 306, the appropriate traceability data is captured and the process returns to 302. If, on the other hand, the food item/ingredient container is not empty, the process continues to 308, and the inventory is updated with a monitoring status (see e.g., the inventory list 400 disclosed in FIG. 4 and described more fully below). Next, at 314, the process determines if it is time to clear the prep table. If it is not time to clear the prep table, the process captures the image at 312 and moves to 310 to analyze the image, checking for empty food item/ingredient containers. If it is time to clear all food items/ingredients off of the prep table, the process continues to 316 where all food items/ingredients on the prep table are checked for viability. Typically, a food item and/or ingredient is considered viable if it has more inventory than the minimum level to retain, and has not exceeded its time limit on the prep table or its expiration date.

At 318, each item on the prep table is processed to be stored, donated or properly disposed of as a waste if, for example, the relevant expiration dates have passed, the food item/ingredient becomes contaminated, spoils, etc. For each food item/ingredient on the prep table, the traceability information is captured and retained, and the process exits at 320. Importantly, a similar process can be used with respect to the traceability of the resulting food product created from the food items and ingredients 106.

FIG. 4 discloses an inventory list 400 showing current weight of the food items/ingredients 106. It will be appreciated by those of ordinary skill in the art, that FIG. 4 depicts just one potential example of inventory list 400, and that any suitable inventory list can be utilized as is known in the art depending on the needs and/or wants of a user. For example, this inventory list 400 comprises an event 402, date 404, global location number (GLN) 406, GLN extension 408, GTIN 410, product lot 412, product serial number 414, product quantity 416, product weight 418, and operator 420. Product outputs can be shown as well as disclosed on the inventor list 400 at 422, as well as production date 424, returnable asset number 426, and returnable asset number extension 428.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A smart prep table device for food traceability comprising:
at least one food item;
an RFID reader; and
an intelligent imaging system.

2. The smart prep table device of claim 1 wherein the RFID reader and the intelligent imaging system gather a set of traceability information from the at least one food item.

3. The smart prep table device of claim 1 further comprising an RFID antenna, and wherein the at least one food item comprises a RFID enabled smart label.

4. The smart prep table device of claim 3 wherein the RFID enabled smart label comprises a set of traceability information about the at least one food item.

5. The smart prep table device of claim 4 wherein the RFID reader reads the set of traceability information from the RFID enabled smart label.

6. The smart prep table device of claim 1 wherein the intelligent imaging system captures at least one image of the at least one food item.

7. The smart prep table device of claim 1 wherein the RFID reader and the intelligent imaging system collect a set of traceability information from the at least one food item and use the set of traceability information to maintain an inventory of the at least one food item.

8. The smart prep table device of claim 7 wherein the smart prep table device uses the set of traceability information to generate an alert for a user.

9. The smart prep table device of claim 7 wherein the set of traceability information comprises one or more of the following in relation to the at least one food item: (a) a name; (b) a supplier name; (c) a GTIN number; (d) a serial number; (e) a weight; (f) a quantity; (g) a production date; and (h) an expiration date.

10. A smart prep table device for food traceability comprising:
at least one food item comprising a RFID enabled smart label;
an RFID reader capable of reading a set of traceability information from the RFID enabled smart label; and
an intelligent imaging system capable of capturing an image of the at least one food item.

11. The smart prep table device of claim 10 wherein the RFID reader communicates with the intelligent imaging system.

12. The smart prep table device of claim 10 wherein the set of traceability information comprises one or more of the following in relation to the at least one food item: (a) a name; (b) a supplier name; (c) a GTIN number; (d) a serial number; (e) a weight; (f) a quantity; (g) a production date; (h) an expiration date; and (i) a readable code.

13. The smart prep table device of claim 10 wherein the smart prep table device uses the set of traceability information to maintain an inventory of the at least one food item.

14. The smart prep table device of claim 10 wherein the set of traceability information is encoded into a QR code.

15. The smart prep table device of claim 10 wherein the smart prep table device uses the set of traceability information to generate an alert for a user.

16. A method of food traceability using a smart prep table and comprising the steps of:
positioning a food item labeled with a smart label on the smart prep table;
using a RFID reader to read the smart label to obtain a first set of information about the food item; and
using an intelligent imaging system to capture and analyze an image of the food item and generate a second set of information.

17. The method of claim 16 further comprising the step of using at least one of the first and second sets of information to maintain an inventory of the food item.

18. The method of claim 16 further comprising the step of using at least one of the first and second sets of information to generate an alert for a user.

19. The method of claim 16 further comprising the step of providing at least one of the first and second sets of information to a user.

20. The method of claim 19 wherein at least one of the first and second sets of information is provided to the user in a QR code.
